(19) United States
(12) Patent Application Publication
(10) Pub. No.: US 2025/0006036 A1
(43) Pub. Date: Jan. 2, 2025

(54) AUTOMATIC PRIORITIZATION AND/OR FAILOVER FOR ANALYTICS DEVICES

(71) Applicant: The ADT Security Corporation, Boca Raton, FL (US)

(72) Inventor: Andrew O’CONNOR, los Angeles, CA (US)

(21) Appl. No.: 18/345,664

(22) Filed: Jun. 30, 2023

(51) Int. Cl. G08B 25/00; G06V 20/52

(52) U.S. Cl. CPC G08B 25/007; G06F 11/0757; G06V 20/52; G06F 11/0793; G06F 11/3058; G06F 11/3409

(57) ABSTRACT

A computing system is described. The computing system is associated with a premises monitoring system that is configured to monitor a premises. The computing system is configured to detect, based on at least one parameter corresponding to a premises analytics device located at the premises, a failure condition associated with the premises analytics device, the premises analytics device having been configured to execute a pipeline, in response to detecting the failure condition, identify at least one additional premises analytics device associated with the premises monitoring system that is capable of executing the pipeline, and cause a pipeline deployment based on the pipeline being deployed to the at least one additional premises analytics device

### TECHNICAL FIELD

The present disclosure is generally related to analytics pipeline management systems.

### BACKGROUND

Systems that perform video analytics may use computer-based pattern recognition techniques to detect objects or activities depicted in video. For example, some video analytics systems use so-called “artificial intelligence,” such as systems that apply object detection models that have been trained using artificial neural networks, to perform video analytics functionality. Computing devices that perform video analytics often have a graphic processing unit (GPU) to facilitate video processing.

### BRIEF DESCRIPTION OF THE DRAWINGS

A more complete understanding of the present disclosure, and the attendant advantages and features thereof, may be more readily understood by reference to the following detailed description when considered in conjunction with the accompanying drawings wherein:

FIG. 1 is a schematic diagram of a representation of an example of a pipeline according to various embodiments of the present disclosure;

FIG. 2 is a schematic diagram of an example system according to various embodiments of the present disclosure;

FIG. 3 is a block diagram of an example of premises analytics devices in a premises monitoring system of FIG. 2 according to various embodiments of the present disclosure;

FIG. 4 is a block diagram of an example computing environment of FIG. 2 according to various embodiments of the present disclosure; and

FIG. 5 is a flowchart of an example process according to some embodiments of the present disclosure.

### DETAILED DESCRIPTION

The present disclosure relates to systems in which a pipeline management platform may be used to develop, deploy and/or manage analytics functionality, such as video and/or audio analytics functionality. Some embodiments may facilitate video and/or audio analytics functionality by providing automatic failover of pipelines associated with one or more premises analytics devices of premises monitoring systems.

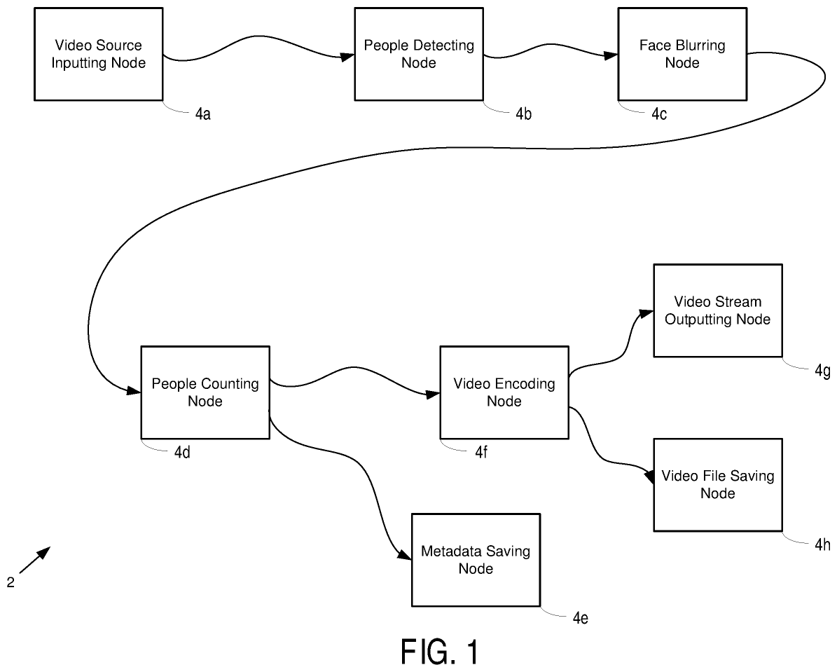

With reference to FIG. 1, shown is a diagram depicting an example analytics pipeline 2 according to various embodiments. A pipeline 2 may be, for example, a chain of data processing operations that are applied to a data stream comprising, for example, video data, audio data, textual data, tabular data, etc. In various embodiments, a pipeline 2 may include multiple nodes that represent data processing operations performed in the pipeline. For example, the pipeline 2 illustrated in FIG. 1 is a video analytics pipeline that includes various nodes 4a-n (collectively referred to as nodes 4). For example, nodes 4 include a video source inputting node 4a, a people detecting node 4b, a face blurring node 4c, a people counting node 4d, a metadata saving node 4e, a video encoding node 4f, a video stream outputting node 4g, and a video file saving node 4h. Some nodes 4, such as the video source inputting node 4a, metadata saving node 4e, video stream outputting node 4g, video encoding node 4f, and video file saving node 4h, may perform operations that input, output and/or save video stream data associated with the pipeline 2. Other nodes 4, such as the people detecting node 4b, the face blurring node 4c, and the people counting node 4d, may perform analytics operations that, for example, detect objects, manipulate video data, and/or count objects depicted in video. Each node 4 in pipeline 2 that performs analytics operations may apply one or more models that have been trained using artificial neural networks or other model training techniques. Other embodiments of pipelines 2 may include different types and/or arrangements of nodes 4 other than the nodes 4 illustrated in FIG. 1.

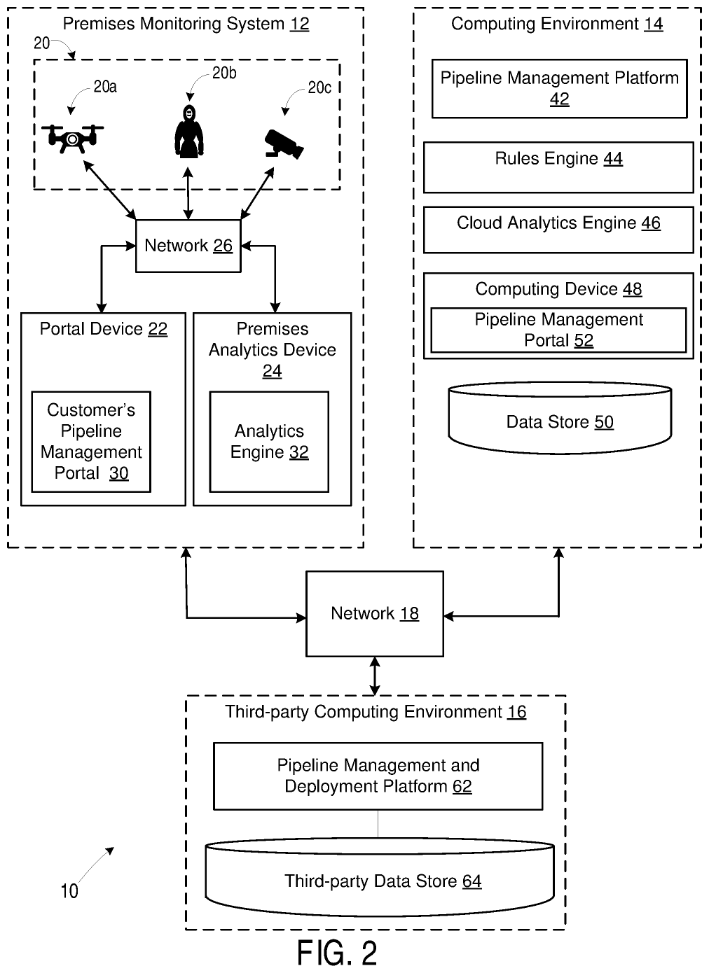

In various embodiments, a pipeline 2 may be created and/or modified using a graphical pipeline editor. The graphical pipeline editor may include a user interface in which a visual representation of a pipeline 2 is rendered. The user interface of the graphical pipeline editor may also facilitate a user adding nodes 4 by dragging-and-dropping the nodes 4 into a pipeline 2. The user may also remove nodes 4 and/or rearrange nodes 4 using the user interface. Furthermore, the user may define or change various parameters for the nodes 4. In other embodiments, nodes 4 can be created and/or modified using a text-based pipeline editor. According to various embodiments, a pipeline editor may be provided in the customer's pipeline management portal 30 (FIG. 2), the pipeline management portal 52 (FIG. 2), as a dedicated pipeline editor application, or through another type of application.

With reference to FIG. 2, shown is a schematic diagram of system 10 for managing one or more pipelines 2 in, for example, premises monitoring system 12. In particular, system 10 may include a premises monitoring system 12 (e.g., a premises security system), a computing environment or computing system (referred to as “computing environment 14”), a third-party computing environment or third-party computing system (referred to as “third-party computing environment 16”), and a network 18. Premises monitoring system 12 may include one or more of each of the following: media device 20, portal device 22, premises analytics device 24, and network 26. Media device 20 may be configured to collect and transmit data such as video and audio data and/or any other type of data. In some other embodiments, media devices 20, such as UAVs, robots, fixed cameras, and other sources, may be configured to collect video and audio data and other information associated with the premises.

In a nonlimiting example, media device 20 may refer to various media devices 20a, 20b, 20c (collectively, media devices 20). Media device 20a may be configured for flight and/or surveillance and be embodied in the form of various devices that can travel, such as unmanned aerial vehicles (UAVs) (e.g., UAVs comprising cameras and sensors). Media device 20b may be configured as an autonomous humanoid robot (e.g., a robot resembling a human body in shape and configured for predetermined functional purposes, such as interacting with humans, human tools and environments) and may include surveillance cameras, and other devices that collect video and audio data. Media device 20c may be a video camera (which may include one or more sensors) configured to detect motion and/or captures video of events such as thermal imaging cameras.

Portal device 22 may comprise a personal computer, a phone, such as a mobile phone, a smart phone, a client (such as a thin client configurable to communicate with a server), etc. While portal device 22 is shown as being part of premises monitoring system 12, in one or more embodiments, portal device 22 may be separate from or not part of the premises monitoring system 12. Portal device 22 may be configured to perform one or more actions associated with a customer's pipeline management portal 30. For example, an information technology (IT) administrator or other authorized person may use the portal device 22 to access the customer's pipeline management portal 30 to create, modify, and/or control pipelines 2 associated with the premises monitoring system 12. Actions associated with the customer's pipeline management portal 30 may include providing an interface usable to create and modify pipeline deployment(s) running on a premises analytics device 24, requesting and receiving pipelines 2 such as pipelines 2 that are compatible with premises analytics device 24, obtaining a user selection of pipelines 2, transmitting a request of the user selected pipelines 2, etc.

Further, in some embodiments, portal device 22 (e.g., user personal computer) may be configured to provide a user with a customer's pipeline management portal 30 through a web browser or dedicated software application. The customer's pipeline management portal 30 allows a user to create and/or modify pipeline deployment(s) running on premises analytics devices 24. For example, a user (e.g., customer) may request to add people counting functionality and purchase a node 4 or pipeline 2 that incorporates such functionality. The user can also use the customer's pipeline management portal 30 to browse the pipeline deployments that are available based on existing hardware capabilities of the premises analytics device 24 and/or premises monitoring system 12. Additionally, the user can use the customer's pipeline management portal 30 to select or edit various parameters associated with nodes 4 or pipelines 2.

Premises analytics device 24 may be configured to perform functions associated with an analytics engine 32, such as receiving data from media devices 20, performing video and/or audio analytics on the data received from media devices 20 using pipeline(s) 2 to determine whether various events have occurred. In some embodiments, premises analytics device 24 may determine and provide to other components of system 10 parameters associated with premises analytics device 24, such as pipeline information; temperatures of its processing elements or chips, such as processors; watchdog timers; computer resource usage; latency of task execution; heartbeat information; device age information; capabilities of the premises analytics device 24; other information associated with hardware failure and/or software failure; etc. For example, the parameters may be used by other components, such as pipeline management platform 42, to initiate a failover of one or more pipelines 2. That is, premises analytics device 24 may be configured to provide information usable for initiating automatic failover of its pipelines 2, so that at least one other premises analytics device 24 is configured to execute pipelines 2 of a premises analytics device 24 that is associated with a failure.

In one or more embodiments, in addition to the failover of one or more pipelines 2 to a different premises analytics device 24, the configuration of the one or more pipelines 2 may be adjusted as part of the failover process. Two examples of adjusting the configuration of the in one or more pipelines 2 are as follows. Example 1: adjust the frequency in which the one or more pipelines 2 analyze a video feed. For example, in a first functional setup, a video may be analyzed every 5 seconds by the one or more pipelines 2 (e.g., analyzed in predefined intervals to comply with standards from a standards body such as Occupational Safety and Health Administration (OSHA)). In a degraded situation, a second functional setup may be implemented where the one or more pipelines 2 analyze the video in a longer time interval than the first functional setup, e.g., may process and/or analyze the video every 30, 60, or 90 seconds. Example 2: adjust the number of frames that are skipped by the one or more pipelines 2. That is, in degraded situations all of the one or more pipelines 2 may continue to run but the configuration of the one or more pipelines 2 has been adjusted to increase a number of dropped or skipped frames. In various embodiments, the frame skipping may be adjusted based on a type of analytic. For example, an analytic that is used to detect objects that tend to move slowly may allow for the increase of frame skipping without negatively impacting the performance of the analytic. However, frame skipping may be decreased when the type of analytic relates to people detection.

While the examples used herein relate to failure situations for failover of pipeline(s) 2, one or more embodiments described herein are applicable to other situations (non-failure situations) that may also trigger failover or trigger adjustment of pipeline(s) 2 (i.e., adjust of one or more configurations of the pipeline(s)). That is, pipeline(s) 2 could be stopped, started or rearranged in non-failure situations. One example of a non-failure situation may comprise a time-based situation such as a predefined time of day or time period during a day that may trigger pipeline(s) 2 adjustment or failure (without a failure situation being present). Another example of a non-failure situation may relate to the status of the premises monitoring system 12. That is, premises monitoring system 12 shifting from a disarmed state to an armed state, or vice-versa, may trigger an adjustment of pipeline(s) 2 or trigger the failover procedure. In one or more embodiments, different pipeline(s) 2 may be configured to operate according to different states of the premises monitoring system 12, and/or different pipeline(s) may be run on different premises analytic devices 24 based on the state of the premises monitoring system 12. In one example, one pipeline 2 may be prioritized over another pipeline 2 based on a non-failure situation existing.

Network 26 may be configured to provide communication, e.g., wired and/or wireless communication, between two or more components associated with premises monitoring system 12, e.g., media devices 20, portal device 22, and premises analytics device 24. For example, network 26 can include, for example, one or more intranets, extranets, wide area networks (WANs), local area networks (LANs), wired networks, wireless networks, satellite networks, Data Over Cable Service Interface Specification (DOCSIS) networks, cellular networks, Plain Old Telephone Service (POTS) networks, and/or other types of networks. Although network 26 is shown as an intermediate network between components and/or devices of premises monitoring system 12, any component or device may communicate directly with any other component or device of premises monitoring system 12. According to various embodiments, the premises monitoring system 12 may be, for example, a premises security system and/or a premises automation system.

In some embodiments, premises monitoring system 12 (via one or more of media devices 20, premises analytics device 24, and network 26) may be configured to monitor doors, driveway gates, windows, and other openings, or to control lights, appliances, HVAC systems (e.g., temperature, cooling, heating, exhaust fans, etc.), access control, door locks, lawn sprinklers, etc. For example, premises analytics device 24 may use media captured by media device 20 to detect motion and other alarm conditions, such as glass breaking, fire, smoke, temperature chemical compositions, water, carbon monoxide, or other hazardous conditions. In some other embodiments, premises monitoring system 12 may be configured to perform functions such as lifestyle and life safety functions.

In one or more embodiments, premises monitoring system 12 may be located at a premises, such as a home. However, the term “premises” as used herein is not limited to a home and may refer to an office suite, industrial building, warehouse, or any other indoor or outdoor area where the functions provided by premises monitoring system 12 are desired and may include any associated vehicles, such as boats, recreational vehicles (RVs), etc., that may also be monitored as part of premises monitoring system 12.

Computing environment 14 comprises pipeline management platform 42 for performing one or more functions such as performing a failover of pipelines 2 from a premises analytics device 24 to another premises analytics device 24.

In some embodiments, pipeline management platform 42 may be further configured for performing functions such as providing an electronic pipeline marketplace to purchase and/or license pipelines 2 and/or nodes 4, receiving requests to determine available and/or compatible pipelines 2, determining available and/or compatible pipelines 2, transmitting a list including available and/or compatible pipelines 2, managing pipeline deployment(s) such as requesting and receiving pipeline deployments, managing customer subscription tiers, communicating with third-party entities, etc.

In some other embodiments, pipeline management platform 42 may be configured to manage a pipeline marketplace and/or determine what pipelines 2 are available for users of the pipeline marketplace based on one or more conditions or parameters such as hardware at the user's premises, existing pipeline deployment(s) already running on premises analytics device 24, pipeline marketplace subscription service, etc. Further, pipeline management platform 42 may also be configured to communicate with premises analytics device 24 and/or third-party computing environment 16 to facilitate pipeline deployments being sent from third-party computing environment 16 to premises analytics devices 24 (e.g., indirectly via a server)

Computing environment 14 may further comprise rules engine 44, cloud analytics engine 46, computing device 48, and data store 50. Rules engine 44 may be configured to execute various actions in response to various conditions, such as transmitting a notification to a customer or first responders in response to receiving an alarm event indication, such as an indication that smoke or a break-in is detected on the premises associated with premises monitoring system 12. Cloud analytics engine 46 may be configured to perform video and/or audio analytics (e.g., one or more pipelines 2). Cloud analytics engine 46 may be configured to execute pipelines failed over from a premises analytics device 24. For example, cloud analytics engine 46 may execute a subset of the pipelines that were being executed on a failing premises analytics device 24 (while the remaining pipelines 2 are executed by another premises analytics device 24). In another example, cloud analytics engine 46 may execute all the pipelines that were being executed on a failing premises analytics device 24. Computing device 48 may be configured to perform pipeline management portal 52 functions such as providing an interface (e.g., by an operator associated with remoting monitoring of premise monitoring system 12) to create, modify, and deploy pipelines 2. Data store 50 (e.g., a pipeline repository) may be configured to store data such as data associated with parameters and capabilities of premises analytics devices 24, pipeline deployments being used on premises analytics devices 24, etc.

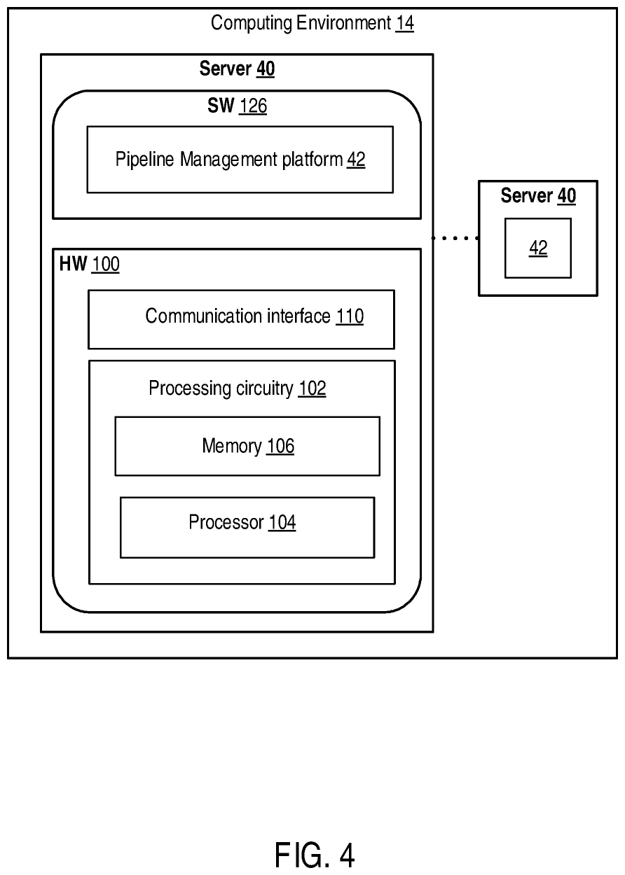

Rules engine 44, cloud analytics engine 46, and data store 50 may be comprised in one or more servers of computing environment 14, as described with respect to FIG. 4, and/or the functions associated with rules engine 44, cloud analytics engine 46, and/or data store 50 may be performed by one or more servers (and/or one or more of its components). Similarly, computing device 48 may be a computer or server, and the functions associated with computing device 48 may be performed by a computer or server (e.g., server and/or one or more of its components).

Third-party computing environment 16 may comprise pipeline management and deployment platform 62 that is configured to perform one or more functions described herein, such as receiving a request to deploy pipelines 2, managing conversion of pipelines 2 into pipeline deployments, transmitting pipeline deployments, etc. Third-party computing environment 16 may provide an application programming interface (API) to facilitate communication with the computing environment 14 and/or other systems. Third-party computing environment 16 may further comprise third-party data store 64 (e.g., a pipeline repository) configured to store data associated with pipelines 2 and deployments. Third-party computing environment may be provided by one or more third-party servers (not shown) that may have that same or similar hardware as servers 40 shown in FIG. 4.

In one or more embodiments, premises monitoring system 12, computing environment 14 and third-party computing environment 16 may be configured to communicate with each other via one or more communication links and/or protocols via network 18. In particular, network 18 may be configured to provide direct and/or indirect communication, e.g., wired and/or wireless communication, between any two or more components of system 10, e.g., premises monitoring system 12, computing environment 14, and third-party computing environment 16, etc. For example, network 18 may be an internet protocol (IP) network that may be established as a wide area network (WAN) and/or local area network (LAN), among other IP-based networks, etc. Although network 18 is shown as an intermediate network between components/devices of system 10, any component or device may communicate directly with any other component or device of system 10.

In some other embodiments, pipeline management platform 42 may perform a failover of pipelines 2 that are expected to be executed by premises analytics device 24, where the pipeline management platform 42 causes cloud analytics engine 46 to execute such pipelines 2. The failover may be temporary, such as until another premises analytics device 24 is configured by pipeline management platform 42 to execute the pipelines 2 of the failed premises analytics device 24. In some embodiments, as more computing resources are available to the cloud analytics engine 46 than the analytics engine 32 of premises analytics device 24 (e.g., premises analytics device 24 may delegate the performing of at least some analytics (e.g., one or more nodes 4 and/or pipelines 2) to the cloud analytics engine 46.

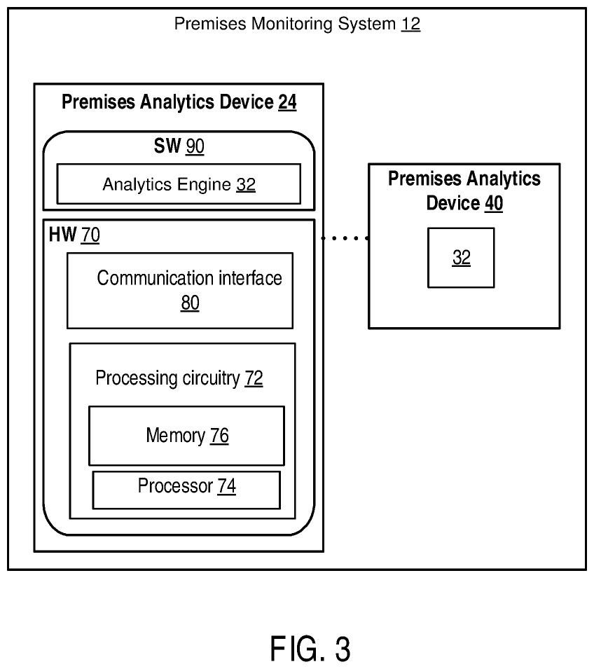

Referring now to FIG. 3, the premises monitoring system 12 includes one or more premises analytics devices 24. In one or more embodiments, premises analytics device 24 is a specialized single-board device such as an embedded system-on-modules (SOMs). Premises analytics device 24 may include hardware 70, including processing circuitry 72 and/or communication interface 80. The processing circuitry 72 may include one or more memories 76 and one or more processors 74. Each processor 74 may include and/or be associated with one or more central processing units, data buses, buffers, and interfaces to facilitate operation In addition to, or instead of a processor 74 and memory, the processing circuitry 72 may comprise integrated circuitry for processing and/or control. Integrated circuitry may include one or more processors and/or processor cores and/or Field Programmable Gate Arrays (FPGAs) and/or Application Specific Integrated Circuits (ASICs), graphics processing units (GPUs), Systems on Chips (SoCs), configured to execute instructions. The processor 74 may be configured to access (e.g., write to and/or read from) the memory 76, which may comprise any kind of volatile and/or nonvolatile memory, e.g., cache and/or buffer memory and/or random access memory (RAM) and/or read-only memory (ROM) and/or optical memory and/or erasable programmable read-only memory (EPROM). In various embodiments, the processing circuitry 72 may be configured to perform various actions by storing computing instructions in the memory 76 that may be executed by processor 74. Communication interface 80 may comprise and/or be configured to support communication with one or more components of system 10 or other component or device using one or more communication protocol.

Premises analytics device 24 may further include software 90 stored internally in, for example, memory 76 or stored in external memory (e.g., database, storage array, network storage device, etc.) accessible by premises analytics device 24 via an external connection. The software 90 may include analytics engine 32. Software 90 (and/or analytics engine 32) may be executable by the processing circuitry 72. The processing circuitry 72 may be configured to control any of the methods and/or processes described herein and/or to cause such methods, and/or processes to be performed, e.g., by premises analytics device 24. Processor 74 corresponds to one or more processors 74 for performing premises analytics device 24 functions described herein. The memory 76 is configured to store data, programmatic software code and/or other information described herein.

In some embodiments, the software 90 may include instructions that, when executed by the processor 74 and/or processing circuitry 72, causes the processor 74 and/or processing circuitry 72 to perform the processes described herein with respect to premises analytics device 24. For example, processing circuitry 72 of the premises analytics device 24 may perform one or more analytics engine 32 functions. Accordingly, by having computer instructions stored in memory 76 accessible to the processor 74, the processor 74 may be configured to perform the actions described herein

Communication interface 80 may include at least a radio interface configured to set up and maintain a wireless connection with network 18 and/or 26. The radio interface may be formed as, or may include, for example, one or more radio frequency (RF) transmitters, one or more RF receivers, and/or one or more RF transceivers. Communication interface 80 may include a wired communication interface, such as Ethernet, configured to set up and maintain a wired connection with network 18 and/or 26.

In some embodiments, a premises analytics device 24 is configured to perform one or more pipeline management platform 42 functions, such, for example, determining that a premises analytics device 24 has failed or is about to fail and causing another premises analytics device 24 to execute the pipelines 2 of the failing or failed premises analytics device 24.

Referring now to FIG. 4, computing environment 14 comprises one or more servers 40 configured to perform one or more functions of computing environment 14. Server 40 may include hardware 100, including processing circuitry 102, and/or communication interface 110. The processing circuitry 102 may include one or more memories 106 and one or more processors 104. Each processor 104 may include and/or be associated with one or more central processing units, data buses, buffers, and interfaces to facilitate operation. In addition to, or instead of a processor 104 and memory, the processing circuitry 102 may comprise integrated circuitry for processing and/or control. Integrated circuitry may include one or more processors 104 and/or processor cores and/or FPGAs and/or ASICs, GPUs, SoCs, configured to execute instructions. The processor 104 may be configured to access (e.g., write to and/or read from) the memory 106, which may comprise any kind of volatile and/or nonvolatile memory, e.g., cache and/or buffer memory and/or RAM and/or ROM and/or optical memory and/or EPROM. Communication interface 110 may comprise and/or be configured to support communication with one or more components of system 10 or other component or device using one or more communication protocols.

Server 40 may further include software 126 stored internally in, for example, memory 106 or stored in external memory (e.g., database, storage array, network storage device, etc.) accessible by server 40 via an external connection. The software 126 may include pipeline management platform 42. Software 126 (and/or pipeline management platform 42) may be executable by the processing circuitry 102. The processing circuitry 102 may be configured to control any of the methods and/or processes described herein and/or to cause such methods, and/or processes to be performed, e.g., by server 40. Processor 104 corresponds to one or more processors 104 for performing server 40 functions described herein. The memory 106 is configured to store data, programmatic software code and/or other information described herein.

In some embodiments, the software 126 may include instructions that, when executed by the processor 104 and/or processing circuitry 102, causes the processor 104 and/or processing circuitry 102 to perform the processes described herein with respect to server 40. For example, processing circuitry 102 may perform one or more pipeline management platform 42 functions, as described herein. Accordingly, by having computer instructions stored in memory 106 accessible to the processor 104, the processor 104 may be configured to perform the actions described herein

In one or more embodiments, the functionality of one or more of rules engine 44 and/or cloud analytics engine 46 and/or pipeline management platform 42 may be performed by server 40 or may be distributed across a plurality of servers 40.

Communication interface 110 may include at least a radio interface configured to set up and maintain a wireless connection with network 18 and/or 26. The radio interface may be formed as, or may include, for example, one or more RF transmitters, one or more RF receivers, and/or one or more RF transceivers. Communication interface 110 may include a wired communication interface, such as an Ethernet interface, configured to set up and maintain a wired connection with network 18 and/or 26.

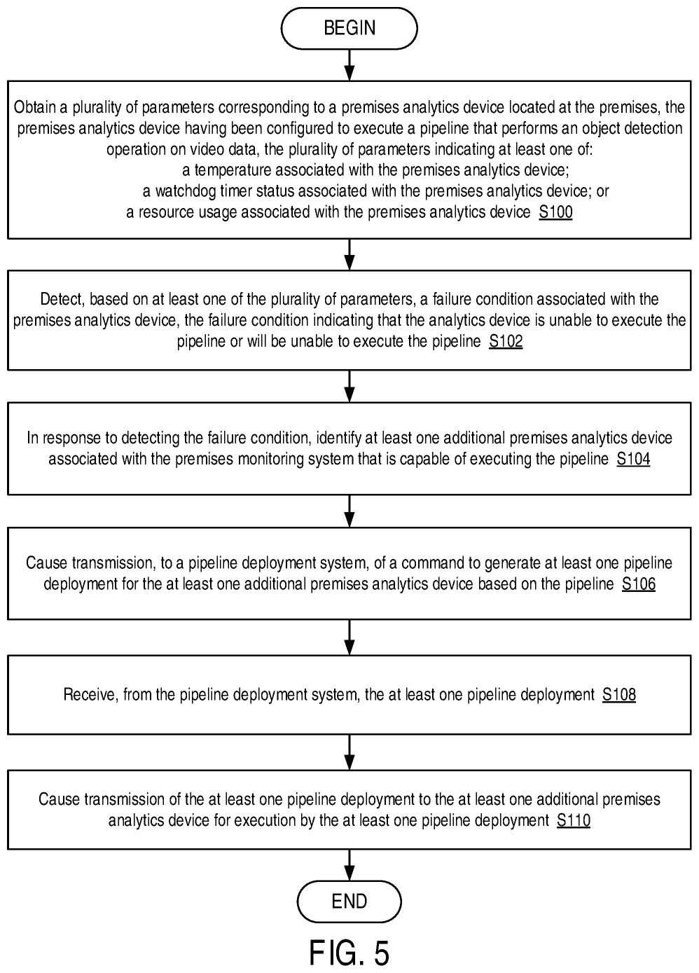

FIG. 5 is a flowchart of an example process (i.e., method) implemented by a computing environment 14 (i.e., computing system) according to some embodiments of the present disclosure. Computing environment 14 may be associated with premises monitoring system 12 that is configured to monitor a premises. One or more blocks described herein may be performed by one or more elements of computing environment 14 such as pipeline management platform 42 via, for example, one or more elements of one or more servers 40 (e.g., processing circuitry 102 and/or communication interface 110).

Computing environment 14 is configured to obtain (Block S100) a plurality of parameters corresponding to a premises analytics device 24 located at the premises, where the premises analytics device 24 has been configured to execute a pipeline 2 that performs an object detection operation on video data, as described herein. The plurality of parameters indicates at least one of: a temperature associated with the premises analytics device, a watchdog timer status associated with the premises analytics device, or a resource usage associated with the premises analytics device 24. Computing environment 14 is further configured to detect (Block S102), based on at least one of the plurality of parameters, a failure condition associated with the premises analytics device 24 where the failure condition indicates that the premises analytics device 24 is unable to execute the pipeline 2 or will be unable to execute the pipeline 2, as described herein.

Computing environment 14 is further configured to, in response to detecting the failure condition, identify (Block S104) at least one additional premises analytics device 24 associated with the premises monitoring system 12 that is capable of executing the pipeline 2, as described herein. Computing environment 14 is further configured to cause (Block S106) transmission, to a pipeline deployment system (e.g., third-party computing environment 16), of a command to generate at least one pipeline deployment for the at least one additional premises analytics device 24 based on the pipeline 2, as described herein. Computing environment 14 is further configured to receive (Block S108), from the pipeline deployment system, the at least one pipeline deployment. Computing environment 14 is further configured to cause (Block S110) transmission of the at least one pipeline deployment to the at least one additional premises analytics device 24 for execution by the at least one premises analytics device 24.

According to some embodiments, the plurality of parameters comprises or further comprises one or more of: latency in task execution relative to expected times for tasks to be performed, lack of heartbeat response from the premises analytics device 24, failure of the premises analytics device 24 to respond to commands, failure of the premises analytics device 24 to perform analytics, age of the premises analytics device 24, capabilities of the premises analytics device 24, and information indicating a failure or impending failure of hardware or software of the premises analytics device 24.

According to some embodiments, computing environment 14 is further configured to initiate a reboot process at the premises analytics device 24 based on the failure condition and at least one additional parameter where the causing of pipeline deployment to be deployed to the at least one additional premises analytics device 24 is based at least on the reboot process being unsuccessful.

According to some embodiments, the at least one additional parameter comprises one or more of: business logic information, a time of day, a type of a failure associated with premises analytics device 24, and whether the failure is also associated with another premises analytics devices 24.

According to some embodiments, computing environment 14 is further configured to cause transmission, to a pipeline deployment system (e.g., third-party computing environment 16), of a command to generate the pipeline deployment for the at least one additional premises analytics device 24 based on the pipeline 2, and receive, from the pipeline deployment system, the pipeline deployment.

According to some embodiments, wherein the causing of the pipeline deployment to be deployed to the at least one additional premises analytics device 24 comprises causing transmission of the pipeline deployment to the at least one additional premises analytics device 24 for execution by the at least one additional premises analytics device 24.

According to some embodiments, computing environment 14 is further configured to temporarily delay, based on at least one rule, the causing of the pipeline deployment to be deployed to the at least one additional premises analytics device 24.

According to some embodiments, the pipeline 2 is configured to perform an object detection operation on video data.

Having described the general process flow of arrangements of the disclosure and having provided examples of hardware and software arrangements for implementing the processes and functions of the disclosure, the sections below provide details and examples of arrangements for performing one or more actions associated with a failover procedure provided by, for example, pipeline management platform 42 that manages failover of one or more pipelines 2 associated with premises monitoring system 12.

In some embodiments, the failover procedure is implemented for premises analytics devices 24 (e.g., edge devices) that are used to perform video and/or audio analytics at a customer's premises. If a premises analytics device 24 has failed (or a failure is determined to be imminent), the pipelines 2 running on the premises analytics device 24 are automatically deployed to another available premises analytics device 24. The particular premises analytics device 24 to which the pipeline(s) 2 is deployed can be chosen based on one or more factors, such as the relative criticality of one or more pipeline 2 that is already executing on the premises analytics device 24.

In some other embodiments, a premises may include multiple premises analytics devices 24, and each premises analytics device 24 may run one or more pipelines 2 from media devices 20 (e.g., video and/or audio devices). If one or more pipelines 2 on multiple premises analytics devices 24 have failed or failure is determined to be imminent, the one or more pipelines 2 may be automatically deployed on one or more other premises analytics devices 24, as described herein.

In some embodiments, pipeline management platform 42 can be configured to facilitate installation of pipelines 2 (e.g., using deployments provided by pipeline management and deployment platform 62 of third-party computing environment 16 and pipelines requested via customer's pipeline management portal 30). In some other embodiments, pipeline management platform 42 can also monitor a parameters associated with premises analytics devices 24 and/or their pipeline(s) 2. In some embodiments, these parameters can include information associated with temperature of various chips or processing elements (i.e., processors such as CPUs, GPUs, etc.) or other components associated with premises analytics devices 24, watchdog timer statuses associated with various chips, computing resource usage, such as CPU, GPU, memory, and network usage, latency in task execution (relative expected times for tasks to be performed), no device “heartbeat” response, failure to respond to commands, failure to perform analytics, age of the premises analytics devices 24, capabilities of the premises analytics devices 24, and any other information indicating a failure or impending failure of hardware and/or software.

In some embodiments, instead of pipeline management platform 42 performing the monitoring of premises analytics devices 24 for failover purposes, premises analytics devices 24 can monitor each other, or another device (e.g., portal device 22) at the customer's premises can monitor premises analytics devices 24 to perform one or more pipeline failover actions. That is, premises analytics devices 24 (and other devices) may be configured to manage pipeline failover.

In some other embodiments, if a parameter is outside a predefined range, the pipeline management platform 42 may determine there is an issue, or that there will soon be an issue, with the premises analytics device 24 or with the ability the premises analytics device 24 to execute pipelines 2. In response, the pipeline management platform 42 can initiate a failover procedure, which involves, for example, one or more of the following steps. Pipeline management platform 42 may determine whether to wait or attempt to reboot the failed premises analytics device 24 (which can be based one or more parameters such as business logic, time of day, nature of the detected problem, whether there are issues with other edge devices, etc.). Pipeline management platform 42 may further identify pipelines 2 that were being executed on the failed premises analytics device 24 and its priority (e.g., factor in business logic, time of day, whether the premises is a store that is currently open or closed), identify other premises analytics devices 24 capable of executing pipelines, select new premises analytics device 24 to execute pipeline(s) based on various factors, such as priority of pipeline(s) (e.g., factoring in business logic), and cause the new premises analytics device 24 to be reconfigured to execute the pipeline(s).

In some embodiments, pipeline management platform 42 can implement rules so that the premises analytics device 24 is not constantly being reconfigured. The rules may include a delay rule that causes a hold-off period before the reconfiguration or failover is triggered.

In some other embodiments, pipeline management platform 42 can also transmit alerts to devices associated with the customer or technicians based on the nature of the issue and/or how the premises analytics device 24 are configured or reconfigured with pipelines and/or pipeline deployments.

In some embodiments, as part of a failover process, pipeline management platform 42 may determine to shift the execution of at least some pipelines 2 of the premises analytics device 24 to another component that is not a premises analytics device 24, such as cloud analytics engine 46. The determination to shift the execution of at least some pipelines 2 may be based on parameters associated with pipelines 2 and/or parameters associated with the other component (e.g., cloud analytics engine 46) and/or parameters associated with the failed premises analytics device 24 and/or other premises analytics devices 24 capable of executing at least some of the pipelines 2. For example, when a first premises analytics device 24 fails, all the pipelines 2 on the first premises analytics device 24 can be executed in the cloud analytics engine 46 of computing environment 14. In another example, pipeline management platform 42 may determine to distribute the execution of the pipelines 2 of the premises analytics device 24 between an additional premises analytics device 24 and cloud analytics engine 46. The distribution of pipelines 2 may include shifting a first subset of the pipelines 2 of premises analytics device 24 to the additional premises analytics device 24 and shifting a second subset of the pipelines 2 (different from the first subset) to the cloud analytics engine 46. The determination of the first subset and the second subset may be based on parameters associated with the pipelines 2, the premises analytics device 24, the additional premises analytics device 24, and cloud analytics engine 46. For example, cloud analytics engine 46 may be better suited for execution of some pipelines 2 than by the additional premises analytics device 24, e.g., processors of cloud analytics engine 46 may be more capable than the additional premises analytics device 24, some pipelines 2 may not be compatible with the additional premises analytics device 24, etc.

In some other embodiments, rather than waiting for the premises analytics device 24 to fail or determining that the premises analytics device 24 is expected to fail, a pipeline 2 is moved, or failed over to another premises analytics device 24, when the pipeline 2 itself is causing performance issues in the premises analytics device 24.

Hence, in one or more embodiments, pipeline management platform 42 of computing environment 14 is advantageously configured to manage failover of pipelines 2 (e.g., allocate pipelines 2) associated with a premises analytics device 24, thereby facilitating uninterrupted or minimally interpreted analytics (of audio and/or video) performed by premises analytics devices 24 of premises monitoring system 12.

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects. Any process, step, action and/or functionality described herein may be performed by, and/or associated to, a corresponding module and/or unit, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions and/or acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function and/or act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions and/or acts specified in the flowchart and/or block diagram block or blocks.

The functions and/or acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings without departing from the scope and spirit of the present disclosure.

What is claimed is:

1. A computing system associated with a premises monitoring system that is configured to monitor a premises, the computing system comprising:
at least one processor; and
at least one memory storing a plurality of instructions that, when executed by the at least one processor, causes the at least one processor to:
obtain a plurality of parameters corresponding to a premises analytics device located at the premises, the premises analytics device having been configured to execute a pipeline that performs an object detection operation on video data, the plurality of parameters indicating at least one of:
a temperature associated with the premises analytics device;
a watchdog timer status associated with the premises analytics device; or
a resource usage associated with the premises analytics device;
detect, based on at least one of the plurality of parameters, a failure condition associated with the premises analytics device, the failure condition indicating that the analytics device is unable to execute the pipeline or will be unable to execute the pipeline;
in response to detecting the failure condition, identify at least one additional premises analytics device associated with the premises monitoring system that is capable of executing the pipeline;
cause transmission, to a pipeline deployment system, of a command to generate at least one pipeline deployment for the at least one additional premises analytics device based on the pipeline;
receive, from the pipeline deployment system, the at least one pipeline deployment; and
cause transmission of the at least one pipeline deployment to the at least one additional premises analytics device for execution by the at least one premises analytics device.

2. A computing system associated with a premises monitoring system that is configured to monitor a premises, the computing system comprising:
at least one processor; and
at least one memory storing a plurality of instructions that, when executed by the at least one processor, causes the at least one processor to:
detect, based on at least one parameter corresponding to a premises analytics device located at the premises, a failure condition associated with the premises analytics device, the premises analytics device having been configured to execute a pipeline;
in response to detecting the failure condition, identify at least one additional premises analytics device associated with the premises monitoring system that is capable of executing the pipeline; and
cause a pipeline deployment based on the pipeline being deployed to the at least one additional premises analytics device.

3. The computing system of claim 2, wherein the plurality of instructions further causes the at least one processor to obtain the at least one parameter corresponding to the premises analytics device.

4. The computing system of claim 2, wherein the at least one parameter comprises one or more of:
a temperature associated with the premises analytics device;
a watchdog timer status associated with the premises analytics device;
a resource usage associated with the premises analytics device.

5. The computing system of claim 4, wherein the at least one parameter comprises one or more of:
latency in task execution relative to expected times for tasks to be performed;
lack of heartbeat response from the premises analytics device;
failure of the premises analytics device to respond to commands;
failure of the premises analytics device to perform analytics;
age of the premises analytics device;
capabilities of the premises analytics device; and
information indicating a failure or impending failure of hardware or software of the premises analytics device.

6. The computing system of claim 2, wherein the plurality of instructions further causes the at least one processor to, initiate a reboot process at the premises analytics device based on the failure condition and at least one additional parameter; and
the causing of pipeline deployment to be deployed to the at least one additional premises analytics device being based at least on the reboot process being unsuccessful.

7. The computing system of claim 6, wherein the at least one additional parameter comprises one or more of:
business logic information;
a time of day;
a type of a failure associated with premises analytics device; and
whether the failure is also associated with another premises analytics devices.

8. The computing system of claim 2, wherein the plurality of instructions further causes the at least one processor to:
cause transmission, to a pipeline deployment system, of a command to generate the pipeline deployment for the at least one additional premises analytics device based on the pipeline; and
receive, from the pipeline deployment system, the pipeline deployment.

9. The computing system of claim 8, wherein the causing of the pipeline deployment to be deployed to the at least one additional premises analytics device comprises causing transmission of the pipeline deployment to the at least one additional premises analytics device for execution by the at least one additional premises analytics device.

10. The computing system of claim 2, wherein the plurality of instructions further causes the at least one processor to temporarily delay, based on at least one rule, the causing of the pipeline deployment to be deployed to the at least one additional premises analytics device.

11. The computing system of claim 2, wherein the pipeline is configured to perform an object detection operation on video data.

12. A method performed by a computing system associated with a premises monitoring system that is configured to monitor a premises, the method comprising:
detecting, based on at least one parameter corresponding to a premises analytics device located at the premises, a failure condition associated with the premises analytics device, the premises analytics device having been configured to execute a pipeline;
in response to detecting the failure condition, identifying at least one additional premises analytics device associated with the premises monitoring system that is capable of executing the pipeline; and
causing a pipeline deployment based on the pipeline being deployed to the at least one additional premises analytics device.

13. The method of claim 12, further comprising obtaining the at least one parameter corresponding to the premises analytics device.

14. The method of claim 12, wherein the at least one parameter comprises one or more of:
a temperature associated with the premises analytics device;
a watchdog timer status associated with the premises analytics device;
a resource usage associated with the premises analytics device.

15. The method of claim 14, wherein the at least one parameter comprises one or more of:
latency in task execution relative to expected times for tasks to be performed;
lack of heartbeat response from the premises analytics device;
failure of the premises analytics device to respond to commands;
failure of the premises analytics device to perform analytics;
age of the premises analytics device;
capabilities of the premises analytics device; and
information indicating a failure or impending failure of hardware or software of the premises analytics device.

16. The method of claim 12, further comprising initiating a reboot process at the premises analytics device based on the failure condition and at least one additional parameter; and
the causing of pipeline deployment to be deployed to the at least one additional premises analytics device being based at least on the reboot process being unsuccessful.

17. The method of claim 16, wherein the at least one additional parameter comprises one or more of:
business logic information;
a time of day;
a type of a failure associated with premises analytics device; and
whether the failure is also associated with another premises analytics devices.

18. The method of claim 12, further comprising:
causing transmission, to a pipeline deployment system, of a command to generate the pipeline deployment for the at least one additional premises analytics device based on the pipeline; and
receiving, from the pipeline deployment system, the pipeline deployment.

19. The method of claim 18, wherein the causing of the pipeline deployment to be deployed to the at least one additional premises analytics device comprises causing transmission of the pipeline deployment to the at least one additional premises analytics device for execution by the at least one additional premises analytics device.

20. The method of claim 12, wherein the pipeline is configured to perform an object detection operation on video data.
